(19) United States
(12) Patent Application Publication
(10) Pub. No.: US 2014/0074418 A1
(43) Pub. Date: Mar. 13, 2014

(54) METHOD AND SYSTEM FOR CALIBRATING AN INERTIAL SENSOR

(71) Applicants: Yizhen Lin, Cohoes, NY (US); Margaret L. Kniffin, Chandler, AZ (US); Andrew C. McNeil, Chandler, AZ (US); Richard N. Nielsen, Mesa, AZ (US)

(72) Inventors: Yizhen Lin, Cohoes, NY (US); Margaret L. Kniffin, Chandler, AZ (US); Andrew C. McNeil, Chandler, AZ (US); Richard N. Nielsen, Mesa, AZ (US)

(73) Assignee: FREESCALE SEMICONDUCTOR, INC., Austin, TX (US)

(21) Appl. No.: 13/614,448

(22) Filed: Sep. 13, 2012

(51) Int. Cl. G01P 21/00; G06F 19/00

(52) U.S. Cl. 702/96; 73/1.37; 73/1.38

(57) ABSTRACT

A calibration system (20) configured for communication with an inertial sensor (22) includes a signal generator (24) and processing system (26). A calibration process (60) performed using the calibration system (20) includes applying (90) an electrical stimulus (44) to the inertial sensor (22), receiving an output signal (46) from the sensor (22) produced in response to the electrical stimulus (44) and determining a sensitivity (108) of the inertial sensor (22) to the electrical stimulus (44) in response to the output signal (46) and an applied voltage of the electrical stimulus (44). A sensitivity (112) of the inertial sensor (22) to an inertial stimulus is calculated using the sensitivity (108) and a measured resonant sensitivity (114) of the inertial sensor (22), and the calculated sensitivity (112) is utilized to adjust a gain value (56) for the inertial sensor (22) to calibrate the sensor (22).

### TECHNICAL FIELD OF THE INVENTION

The present invention relates generally to calibrating inertial sensors. More specifically, the present invention relates to calibrating an inertial sensor without subjecting the sensor to an inertial stimulus.

### BACKGROUND OF THE INVENTION

Microelectromechanical Systems (MEMS) inertial sensors are widely used in applications such as automotive, inertial guidance systems, household appliances, game devices, cellular telephony, protection systems for a variety of devices, and many other industrial, scientific, and engineering systems. Such MEMS sensors are used to sense a physical condition such as acceleration, angular rate, pressure, or temperature, and to provide an electrical signal representative of the sensed physical condition.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of a calibration system used to calibrate an inertial sensor in accordance with an embodiment;

FIG. 2 shows a diagram illustrating an exemplary process parameter that can cause variations in the sensitivity of an inertial sensor;

FIG. 3 shows a flowchart of a calibration process performed using the calibration system;

FIG. 4 shows a top view and a side view of an inertial sensor to be calibrated in accordance with the calibration process;

FIG. 5 shows a diagram illustrating an input of an electrical stimulus for calibrating the inertial sensor of FIG. 4;

FIG. 6 shows a diagram of equations that derive a mathematical definition of electrostatic force when the electrical stimulus is applied to the inertial sensor of FIG. 4;

FIG. 7 shows a diagram of equations that determine a correlation between the electrical stimulus applied to the inertial sensor and an inertial stimulus to which the inertial sensor of FIG. 4 may be subjected;

FIG. 8 shows a diagram of equations used to determine unknown process parameters using a resonant frequency of the inertial sensor;

FIG. 9 shows a top view and a side view of another of another inertial sensor to be calibrated in accordance with the calibration process;

FIG. 10 shows a diagram illustrating an input of an electrical stimulus for calibrating the inertial sensor of FIG. 9;

FIG. 11 shows a diagram of equations that determine a correlation between the electrical stimulus applied to the inertial sensor of FIG. 9 and an inertial stimulus to which the inertial sensor may be subjected;

FIG. 12 shows a block diagram of yet another inertial sensor to be calibrated in accordance with the calibration process;

FIG. 13 shows a diagram illustrating an input of an electrical stimulus for calibrating the inertial sensor of FIG. 12;

FIG. 14 shows a diagram of equations that define an output from the inertial sensor of FIG. 12;

FIG. 15 shows a diagram of output equations to illustrate the application of an electrical stimulus of various voltages which may be applied for calibrating the inertial sensor of FIG. 12;

FIG. 16 shows a diagram of equations used to calibrate sensitivity and offset for the inertial sensor of FIG. 12.

### DETAILED DESCRIPTION

Capacitive-sensing microelectromechanical systems (MEMS) inertial sensor designs, such as accelerometers, angular rate sensors, and so forth, are highly desirable for operation in a wide variety of environments and in miniaturized devices, and due to their relatively low cost. Capacitive inertial sensors sense a change in electrical capacitance, with respect to an inertial stimulus, such as acceleration or angular rate, to vary the output of an energized circuit. The integrated circuit of a MEMS inertial sensor may be calibrated at the factory for sensitivity and offset level. Factory calibrated MEMS inertial sensors can reduce or eliminate the need for end-user calibration. However, accurate calibration of MEMS inertial sensors is critical for achieving reliable output signals.

Traditionally, factory calibration of MEMS sensors is performed using a mechanical platform that precisely moves the MEMS inertial sensors in controlled orientations, and at known accelerations and/or rotational velocities. The output of the inertial sensors are observed and compared with design parameters for the inertial sensors. The MEMS inertial sensors can then be calibrated or trimmed to match the design parameters. The trim values, i.e., the calibration values, are stored inside the MEMS inertial sensor. Thus, any time the device is turned on, the calibration parameters may be employed during normal operation. Unfortunately, the cost of a mechanical platform and associated calibration procedure can be cost and time prohibitive. Furthermore, there is limited parallelism (i.e., how many MEMS devices can be tested at the same time) for systems that require physical stimulus.

Embodiments entail a calibration system and a method for factory calibration of an inertial sensor. The system and methodology directly correlates an inertial, i.e., physical stimulus, with an electrical stimulus applied to the inertial sensor by measuring the resonant frequency of the inertial sensor so that the sensitivity of the inertial sensor can be calibrated, or trimmed, without subjecting the inertial sensor to an inertial stimulus.

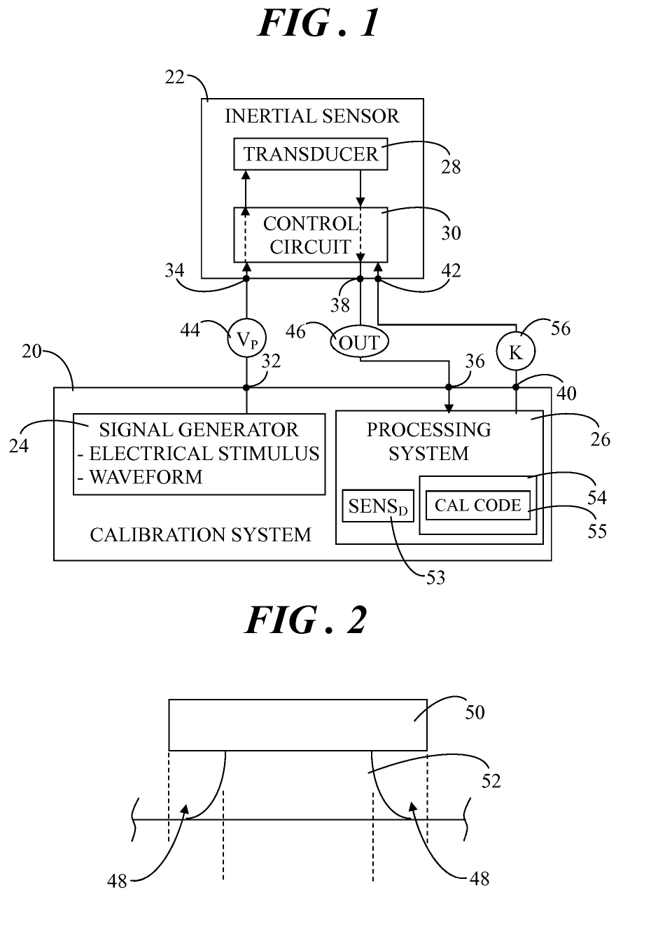

FIG. 1 shows a block diagram of a calibration system 20 used to calibrate an inertial sensor 22 in accordance with an embodiment. In general, calibration system 20 includes a signal generator 24 and a processing system 26, and inertial sensor 22 includes a transducer 28 and a control circuit 30 which may be implemented as an application specific integrated circuit. Calibration system 20 may be external to inertial sensor 22, integrated into inertial sensor 22, or some combination of external and internal integration. Calibration system 20 and calibration methodology will be discussed in connection with the calibration of a single inertial sensor 22 for simplicity of discussion. However, in actual practice, calibration system 20 may be configured to concurrently calibrate multiple inertial sensors 22.

Generally, transducer 28 is a device that converts an input signal, e.g., acceleration, angular rate, and so forth, into another form of energy, e.g., voltage. Control circuit 30 may be any active or passive circuitry used to communicate signals to and from transducer 28, for processing data from transducer 28, for communicating with circuitry outside of inertial sensor 22, and so forth. Inertial sensor 22 may be an acceleration sensor, an angular rate sensor, pressure sensor, and the like that is configured to detect an inertial, or physical, stimulus and convert it to an output signal in the form of, for example, a voltage.

In a calibration configuration, an output element 32 of calibration system 20 is coupled between signal generator 24 and an input 34 of control circuit 30. Additionally, an input element 36 of calibration system 20 is coupled between an output 38 of control circuit 30 and processing system 26. And, a gain adjust output element 40 of calibration system 20 is coupled between processing system 26 and a gain input 42 of inertial sensor 20. Calibration system 20 and its elements are shown in block diagram form for simplicity of illustration. However, those skilled in the art of test equipment will understand that a calibration system containing at least a signal generator and a processing system will include multiple passive and active circuits, connectors, cabling, controls, and the like.

Signal generator 24 produces an electrical stimulus 44 having a suitable amplitude and waveform. Electrical stimulus 44 may be applied to transducer 28 (discussed below) via output of electrical stimulus 44 at output element 32 where it is subsequently input into inertial sensor 22 and suitably communicated to transducer 28 via control circuit 30. As will be discussed in greater detail below, electrical stimulus, V_{P}, 44 is applied to transducer 28 in lieu of an inertial stimulus in order to calibrate inertial sensor 22. In response to electrical stimulus 44, inertial sensor 22 produces an output signal, OUT, 46 which is received at processing system 26 via input element 36.

Inertial sensor 22 is designed to have a particular sensitivity to a physical stimulus, referred to herein as design sensitivity, i.e. SENS_{D}. The sensitivity of an electronic device, such as inertial sensor 22 is the minimum magnitude of input signal required to produce a specific output signal having a specified signal-to-noise ratio, or other specified criteria. In actual practice, the “actual” or “true” sensitivity, i.e. SENS_{P}, of inertial sensor 22 to a physical stimulus may differ from the design sensitivity due to physical variations in the actual structure of inertial sensor 22. These physical variations are referred to herein as process parameters because they occur during the manufacturing, i.e., the processing, operations that yield inertial sensor 22.

Referring to FIG. 2 in connection with FIG. 1, FIG. 2 shows a diagram illustrating a exemplary process parameter that can cause variations in the sensitivity of an inertial sensor. In this illustration, the process parameter is the magnitude of an etch bias 48. Etch bias 48 refers to the difference in etch feature size relative to the printed, i.e., design, feature size. Etch bias 48 introduces deviations in the fabricated inertial sensor from the original design dimensions and shapes. As shown, a photoresist 50 overlies a structural layer 52. Structural layer 52 may be, for example, polysilicon, silicon, metal, oxide, or some other suitable material. Photoresist 50 is often used for the patterning and etching of substrates to fabricate, for example, microelectromechanical systems (MEMS) devices. Photoresist 50 tends to resist etching by solutions when the underlying structural layer 52 is being etched.

Etch bias 48 is one example of a process parameter that can cause variations in the sensitivity of an inertial sensor. Other process parameters may as well.

The magnitude of etch bias 48 provides a measure of the undercut, i.e., an amount of lateral etch in structural layer 52 in this example, underneath photoresist 50 that may occur during etching of structural layer 52. The magnitude of etch bias 48 can cause variation in the actual sensitivity, SENS_{P}, of inertial sensor 22 (FIG. 1) from a predetermined design sensitivity 53, SENS_{D}, known by processing system 26. Calibration of inertial sensor 22 is performed to account for the variability of the actual sensitivity, SENS_{P}, from design sensitivity 53, SENS_{D}. The actual sensitivity, SENS_{P}, is adjusted during calibration to match design sensitivity 53, SENS_{D}. In other words, each inertial sensor 22 is calibrated so that its particular sensitivity, SENS_{P}, matches design sensitivity 53, SENS_{D}.

Accordingly, processing system 26 includes computer readable media 54 (e.g., a memory, firmware, etc.) associated therewith storing executable code 55, labeled CAL CODE. Executable code 55 instructs processing system 26 to determine a first sensitivity of inertial sensor 22 to electrical stimulus 44 in response to output signal 46, calculate a second sensitivity of inertial sensor 22 using the first sensitivity and a resonant frequency of inertial sensor 22, and utilizing the second sensitivity to produce a gain value, K, 56 for inertial sensor 22. Gain value 56 is communicated to inertial sensor 22 via gain adjust output element 40 of calibration system 20 so that its particular sensitivity, SENS_{E}, matches design sensitivity 53, SENS_{D}.

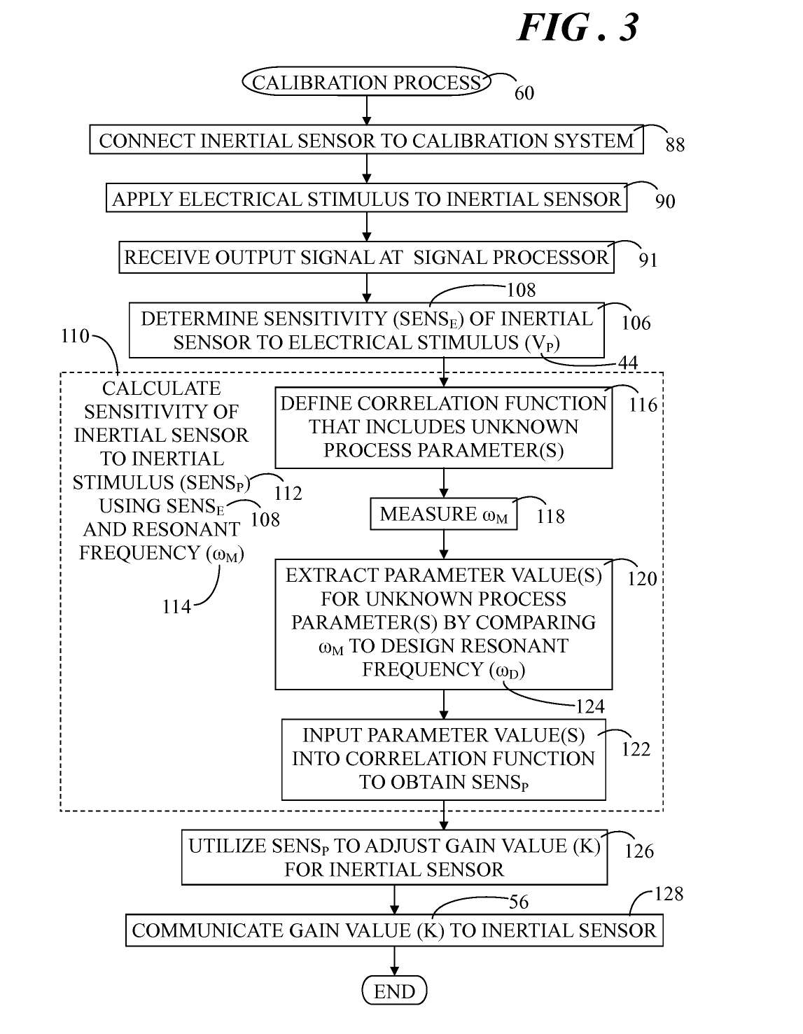

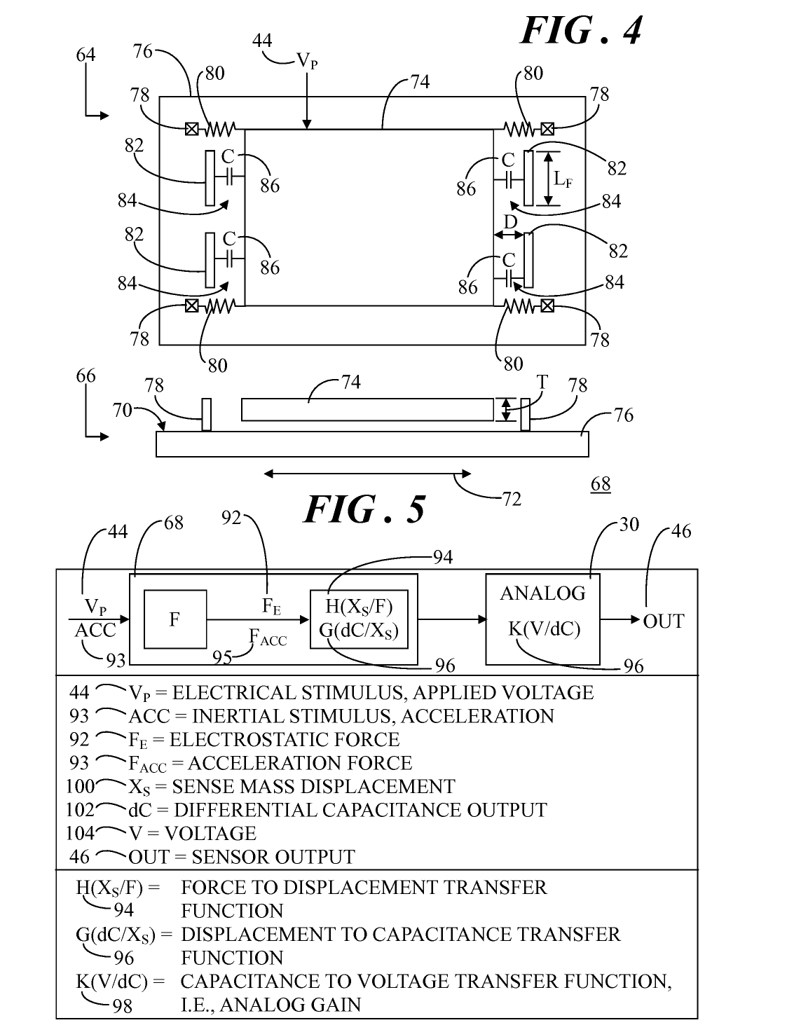

FIG. 3 shows a flowchart of a calibration process 60 performed using calibration system 20 to calibrate inertial sensor 22 (FIG. 1). Calibration process 60 may be performed when CAL CODE 55 (FIG. 1) is executed. Calibration process 60 determines gain value 56 (FIG. 1) so that the sensitivity, SENS_{P}, can be calibrated, or trimmed, without subjecting inertial sensor 22 to an inertial stimulus, i.e. mechanical movement. The operations of calibration process 60 will first be discussed in connection with an example presented in FIGS. 4-8.

FIG. 4 shows a top view 64 and a side view 66 of an inertial sensor to be calibrated in accordance with a subsequent discussion of the operations of calibration process 60. In this example, the inertial sensor includes a lateral acceleration sensor 68, which is adapted to sense acceleration in an X direction 72 (that is, acceleration parallel to a major planar surface of the device). Accordingly, inertial sensor 22 (FIG. 1) is exemplified by lateral acceleration sensor 68. Lateral acceleration sensor 68 includes a movable element, referred to herein as a sense mass 74, suspended above an underlying substrate 76. Suspension anchors 78 are formed on substrate 76 and compliant members 80 interconnect sense mass 74 with suspension anchors 78. Fixed sense fingers 82 are attached to substrate 76 proximate sense mass 74. Sense gaps 84 are thus formed between each of fixed sense fingers 82 and sense mass 74.

In a structure of this type, when sense mass 74 moves in response to acceleration along a sense axis, e.g., the X direction 72, capacitances 86 between fixed sense fingers 82 and sense mass 74 change. Control circuit 30 (represented in FIG. 1) converts these capacitive changes to signals representative of acceleration in X direction 72. It should be understood that the capacitor symbols are symbolic of capacitances 86, and are not physical components of vertical axis acceleration sensor 224.

FIG. 4 includes various symbols representing variables that may be utilized and/or derived when determining gain value 56 (FIG. 1) utilizing calibration process 60 (FIG. 3). Some design variables include, for example, a thickness, T, of the structural layer, i.e. thickness of sense mass 74 shown in side view 66, a length, L_{F}, of each sense finger 82, a number, N, of fixed sense fingers 82 (in this example, N=4), and the width, D, of each sense gap 84. These variables and their significance will be discussed in detail below. A simplified capacitive lateral acceleration sensor 68 is shown for illustrative purposes. It should be understood that a variety of structures may be conceived having differing sizes, shapes, numbers of sense fingers, and the like.

Returning back to FIG. 3, calibration process 60 begins with a task 88. At task 88, lateral acceleration sensor 68 is connected to calibration system 20, as discussed in connection with FIG. 1.

Following task 88, calibration process 60 continues with a task 90. At task 90, electrical stimulus 44 (FIG. 1) is applied to lateral acceleration sensor 68. As particularly shown in FIG. 4, electrical stimulus 44 is applied between sense mass 74 and fixed sense fingers 82. The application of electrical stimulus 44 generates an electrostatic force that moves sense mass 74 along sense axis 72 to simulate acceleration in the sense direction, i.e., X-direction 72.

A task 91 is performed in response to task 90. At task 91, output signal 46 (FIG. 1) is received at processing system 26 (FIG. 1) of calibration system 20.

Referring to FIG. 5 in connection with task 91, FIG. 5 shows a diagram illustrating an input of electrical stimulus 44 for calibrating lateral acceleration sensor 68 and the resulting output signal 46. In response to electrical stimulus 44, lateral acceleration sensor 68 produces an electrostatic force, F_{E}, 92. Electrostatic force 92 is the applied force resulting from electrical stimulus 44. Electrostatic force 92 is processed to yield output signal 46. For example, electrostatic force 92 may be combined with a force to displacement transfer function, H(X_{S}/F), 94, a displacement to capacitance transfer function, G(dC/X_{S}), 96, and a capacitance to voltage transfer function, K(V/dC), 98. Accordingly, H(X_{S}/F) 94, G(dC/X_{S}) 96, and K(V/dC) 98 relate electrostatic force 92 to output signal 46.

Electrical stimulus 44 is applied to lateral acceleration sensor 68 to simulate a physical inertial stimulus, i.e. input acceleration 93. Whereas electrostatic force 92 is the applied force resulting from electrical stimulus 44, an acceleration force, F_{ACC}, 95, is the applied force resulting from acceleration 93. H(X_{S}/F) 94, G(dC/X_{S}) 96, and K(V/dC) 98 are independent of the source of the force, therefore acceleration force, F_{ACC}, 95, may be combined with H(X_{S}/F) 94, G(dC/X_{S}) 96, and K(V/dC) 98 to relate acceleration force to output signal 46 during actual use of lateral acceleration sensor 68.

H(X_{S}/F) 94 is a transfer function which describes the mechanical response of lateral acceleration sensor 68 to an input stimulus (e.g., electrical stimulus 44 or input acceleration 93). For lateral acceleration sensor 68, it is the lateral motion of sense mass 74 (FIG. 3), where X_{S} represents an amount of proof mass displacement 100. In particular, it is a function of how much stimulus is seen by lateral acceleration sensor 68, the mass of sense mass 74, and the stiffness of compliant members 80 (FIG. 3). G(dC/X_{S}) 96 is a transfer function which describes the relationship between displacement, X_{S}, 100 (i.e., the mechanical response), and a differential capacitance output, dC, 102 (i.e., the electrical response). K(V/dC) 98 is a transfer function which describes the conversation of a capacitance, i.e., dC 102, from lateral acceleration sensor 68 to a voltage output, V, 104, of control circuit 30, which the end user actually sees.

The nominal values of transfer functions H(X_{S}/F) 94 and G(dC/X_{S}) 96 result from the design of inertial sensor 22 and cannot be adjusted to change the actual sensitivity, SENS_{P}, of inertial sensor 22. Rather, the inevitable variation of transfer functions H(X_{S}/F) 94 and G(dC/X_{S}) 96 due to processing of inertial sensor 22 can be compensated for by adjusting the gain in control circuit 30 (FIG. 1). This gain adjust is K(V/dC) 98. The gain of transfer function K(V/dC) 98 is adjusted using gain value 56 (FIG. 1) so that lateral acceleration sensor 68 produces the correct voltage output per acceleration input.

Referring back to FIG. 3, following task 91, calibration process 60 continues with a task 106. At task 106, a sensitivity, SENS_{E}, 108, of lateral acceleration sensor 68 (FIG. 4) to electrical stimulus 44 is determined in response to the received value of output signal 46 and an applied voltage, V_{P}, of electrical stimulus 44. In general, SENS_{E} 108 can be determined by dividing the value of the received output signal, OUT 46, by the square of the applied voltage of electrical stimulus 44, V_{P}.

Calibration process 60 continues with a task 110. At task 110, a sensitivity of inertial sensor 22 to an inertial (physical) stimulus, SENS_{P}, 112, is calculated using the sensitivity of inertial sensor 22 to electrical stimulus, SENS_{E}, 108 (determined at task 106) and a resonant frequency, ω_{M}, 114 of sense mass 74 (FIG. 4). Task 110 encompasses a grouping of subtasks 116, 118, 120, and 122 that are distinguished herein by a dashed line box and are individually described for clarity of understanding.

In order to calculate SENS_{P} 112 in accordance with task 110, subtask 116 is performed to ascertain a correlation between the sensitivity of lateral acceleration sensor 68 to an inertial (physical) stimulus, SENS_{P} 112 and the sensitivity of lateral acceleration sensor 68 to electrical stimulus, SENS_{E} 108. Thus, at subtask 116 a correlation function is defined that correlates SENS_{P} 112 with SENS_{E} 108. This correlation function includes at least one unknown process parameter. Subtask 116 is presented in a particular ordering within calibration process 60 to emphasize its relevance to the overall execution of task 110 for calculating SENS_{P} 112 using SENS_{E} 108. However, it should be understood that the correlation function defined at subtask 116 is more likely to be defined as an initial operation of calibration process 60 in accordance with the particular design parameters of lateral acceleration sensor 68 (FIG. 4).

Following subtask 116, subtask 118 is performed to measure resonant frequency, ω_{M}, 114 of lateral acceleration sensor 68 (FIG. 4). As is known, resonant frequency 114 is a frequency with which a system, e.g., lateral acceleration sensor 68, oscillates or vibrates in the absence of external forces. Resonant frequency 114 may be measured using known and upcoming techniques for measuring the frequency response of lateral acceleration sensor 68. An exemplary technique uses a locked-in amplifier that singles out a specific wave, i.e., resonant frequency 114, from the rest of the noise, and “locks on” to the signal, thus enabling accurate measurement of resonant frequency. Of course, other techniques for measuring resonant frequency 114 may alternatively be implemented.

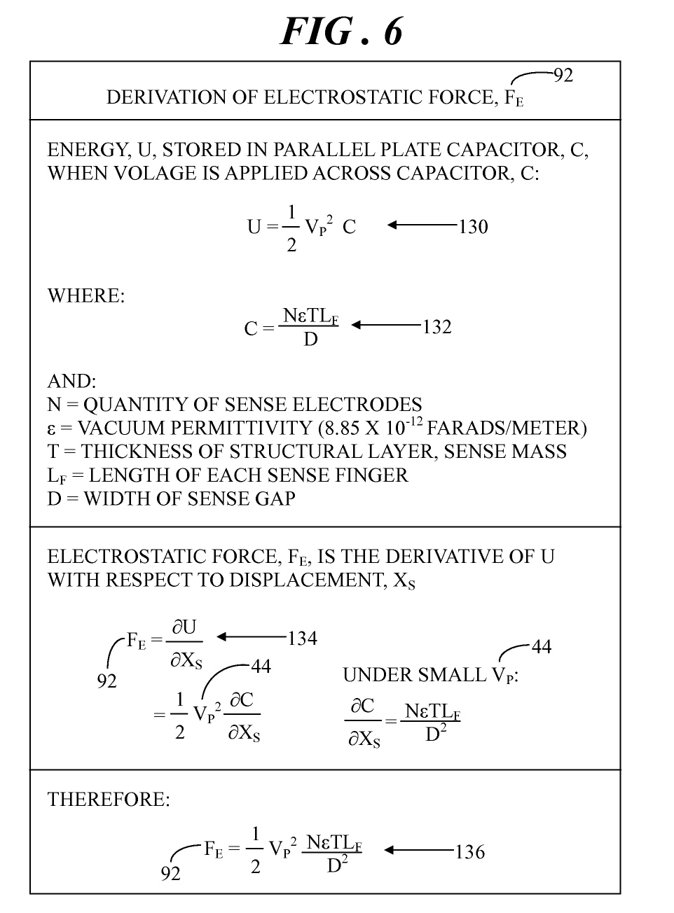

Next, subtask 120 of calculating task 110 is performed to extract parameter values for unknown process parameters by comparing the measured resonant frequency 114, ω_{M}, with a design resonant frequency, ω_{D}, 124 for lateral acceleration sensor 68. Following subtask 120, subtask 122 of calculating task 110 inputs the extracted parameter values into the correlation function defined at subtask 116 to obtain SENS_{P} 112. Subtasks 116, 118, 120, and 122 are discussed below in connection with an example presented in FIGS. 6-8.

Following subtask 122 of task 110, calibration process 60 continues with a task 126. At task 126, SENS_{P} 112 ascertained from calculation task 110 is utilized to adjust gain value 56 (FIG. 1) for lateral acceleration sensor 68. That is, now that SENS_{P} 112 is known from the electrical stimulus test, gain value 56 can be found so that SENS_{P} 112 adjusted by gain value 56 matches design sensitivity 53 (FIG. 1), SENS_{D} for lateral acceleration sensor 68 (FIG. 4). For example, SENS_{P}*K=SENS_{D}. Therefore, K=SENS_{D}/SENS_{P}.

Next, at a task 128, gain value 56 is communicated from calibration system 20 (FIG. 1) to lateral acceleration sensor 68 via gain adjust output element 40 (FIG. 1). As such, capacitance to voltage transfer function, K(V/dC) 98 is suitably adjusted using gain value 56 so that the actual sensitivity, SENS_{P} 112, matches design sensitivity 53, SENS_{D} for lateral acceleration sensor 68 (FIG. 4). Calibration process 60 ends following task 128.

Referring to now FIG. 6 in order to further the understanding of calculating task 110, FIG. 6 shows a diagram of equations that derive a mathematical definition of electrostatic force 92 when electrical stimulus 44 is applied to lateral acceleration sensor 68

(FIG. 4). A formula for electrostatic force 92 is derived by taking the energy, U, stored in a parallel plate capacitor, C, when voltage is applied across the capacitor. The derivative of the equation with respect displacement, X, is taken to yield electrostatic force 92. Thus, an energy equation 130 represents the energy, U, stored in a parallel plate capacitor, C, when electrical stimulus 44, V_{P}, is applied across the capacitor, C. A capacitance equation 132 correlates the capacitance, C, with the quantity, N, of fixed sense fingers 82 (FIG. 4), a vacuum permittivity value, ε, thickness, T, of the structural layer, the length of each sense finger, L_{F}, and the width, D, of sense gaps 84 (FIG. 4).

An equation 134 defines electrostatic force 92 as the derivative of the energy, U, with respect to displacement, X_{S}, of sense mass 74 (FIG. 4) along the sense axis, i.e., X direction 72. Mathematical manipulation of equation 134 yields a final equation for electrostatic force 92, i.e., an electrostatic force equation 136, under a small voltage of electrical stimulus 44.

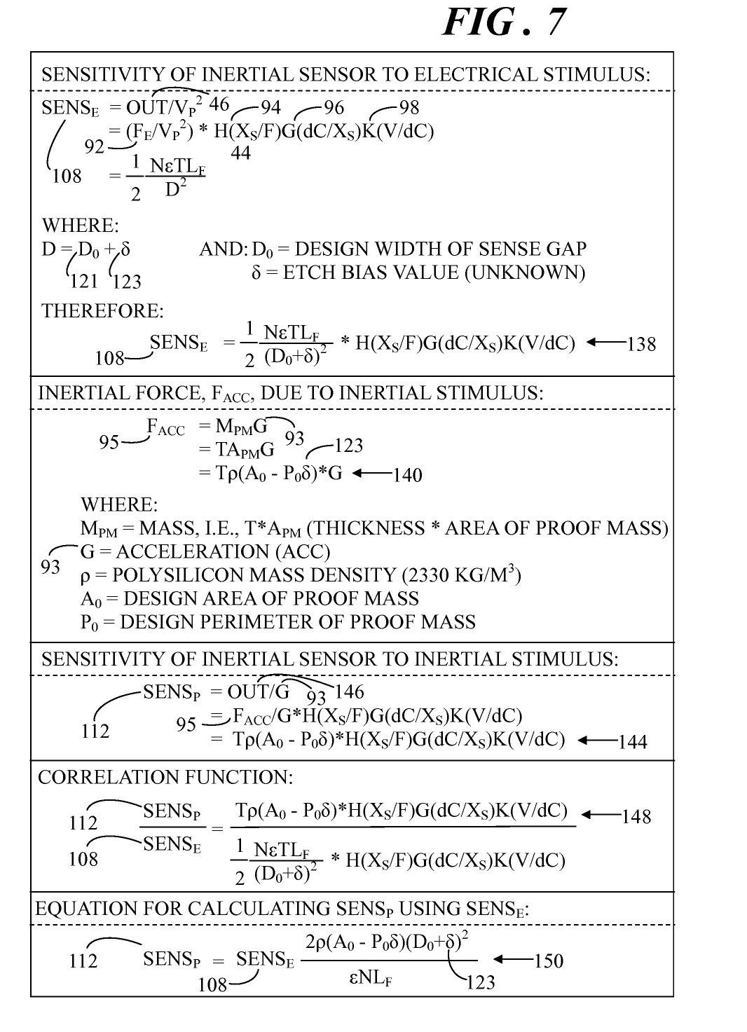

Now referring to FIG. 7, FIG. 7 shows a diagram of equations that determine a correlation between electrical stimulus 44 applied to lateral acceleration sensor 68 (FIG. 4) and an inertial (mechanical) stimulus to which lateral acceleration sensor 68 may be subjected. A sensitivity equation 138 provides a mathematical definition of sensitivity, SENS_{E}, 108, of lateral acceleration sensor 68 to electrical stimulus 44. That is, sensitivity equation 138 relates electrostatic force 92 and electrical stimulus 44 to output signal 46. As represented by sensitivity equation 138, electrostatic force equation 136 (FIG. 6) replaces F_{E} in sensitivity equation 138. Transfer functions H(X_{S}/F) 94, G(dC/X_{S}) 96, and K(V/dC) 98 are applied to relate electrostatic force 92 to output signal 46, as discussed above. However, the width, D, of sense gap 84 (FIG. 4) can vary from its design width, D₀, 121 by an unknown etch bias value, 6, 123. Substituting the sum of design width, D₀, 121 and etch bias value, 6, 123 for the width, D, of sense gap 84 produces sensitivity equation 138. Accordingly, sensitivity equation 138 describing SENS_{E}, includes one unknown process parameter, etch bias value 123.

Electrostatic force equation 136 (FIG. 6) mathematically defines the applied electrostatic force, F_{E}, 92 to sense mass 74 (FIG. 4) resulting from electrical stimulus 44. Sensitivity equation 138 mathematically defines the sensitivity, SENS_{E}, 110 of lateral acceleration sensor 68 to electrical stimulus 44. As further shown in FIG. 7, an inertial force equation 140 mathematically defines acceleration force, F_{ACC}, 95 to sense mass 74 due to an inertial stimulus (i.e., input acceleration 93) and a sensitivity equation 144 may be used to define the sensitivity, SENS_{P} 112, of lateral acceleration sensor 68 to acceleration force 95.

As shown in inertial force equation 140, inertial force, F_{ACC}, 142 is a product of the mass, M_{PM}, of sense mass 74 (FIG. 4) and input acceleration, G, 93. However, the mass, M_{PM}, is a product of the thickness, T, of sense mass 74 and an area, A_{PM}, of sense mass 74. And, area, A_{PM}, is defined in terms of polysilicon mass density, ρ, design area, A₀, of sense mass 74, the design perimeter, P₀, of sense mass 74, and etch bias value, δ, 123. Polysilicon mass density, ρ, design area A₀, and the design perimeter P₀ are all known. Therefore, in this example, inertial force equation 140 includes a single unknown process variable, namely, etch bias value 123.

Sensitivity equation 144 provides a mathematical definition of sensitivity, SENS_{P} 112, of lateral acceleration sensor 68 to input acceleration 93. That is, sensitivity equation 144 relates acceleration force, F_{ACC}, 95 and the input acceleration 93 to output signal, OUT, 46. As represented by sensitivity equation 144, inertial force equation 140 replaces F_{ACC} in sensitivity equation 144 and transfer functions H(X_{S}/F) 94, G(dC/X_{S}) 96, and K(V/dC) 98 are applied to relate acceleration force 95 to output signal 46. Accordingly, sensitivity equation 144 describing SENS_{P} 112, also includes one unknown process parameter, etch bias value 123.

A correlation function 148 is defined in accordance with subtask 116 (FIG. 3) of calibration process 60 (FIG. 3) as a ratio of SENS_{P} to SENS_{E}. Simplification of correlation function 148 yields an equation 150 for calculating SENS_{P} 112, i.e., the sensitivity of lateral acceleration sensor 68 to an inertial stimulus (i.e., input acceleration 93) using SENS_{E} 108, i.e., the sensitivity of lateral acceleration sensor 68 to electrical stimulus 44. Note that equation 150 for calculating SENS_{P} 112 also depends upon a single unknown process parameter, etch bias value, δ, 123. Accordingly, if etch bias value, δ, 123 is known, SENS_{P} 112 can be readily calculated using SENS_{E} 108.

As mentioned above, etch bias 48 (FIG. 2) introduces deviations in the fabricated inertial sensor from the original design dimensions and shapes. Etch bias value, δ, 123 cannot efficiently be directly measured for each lateral acceleration sensor 68 that is being calibrated. However, it was determined that etch bias value, δ, 123 can be obtained by measuring resonant frequency, ω_{M}, 114 of lateral acceleration sensor 68 per subtask 118 (FIG. 3), and comparing measured resonant frequency, ω_{M}, 114 with design resonant frequency, ω_{D}, 124 and the known geometrical design parameters of lateral acceleration sensor 68.

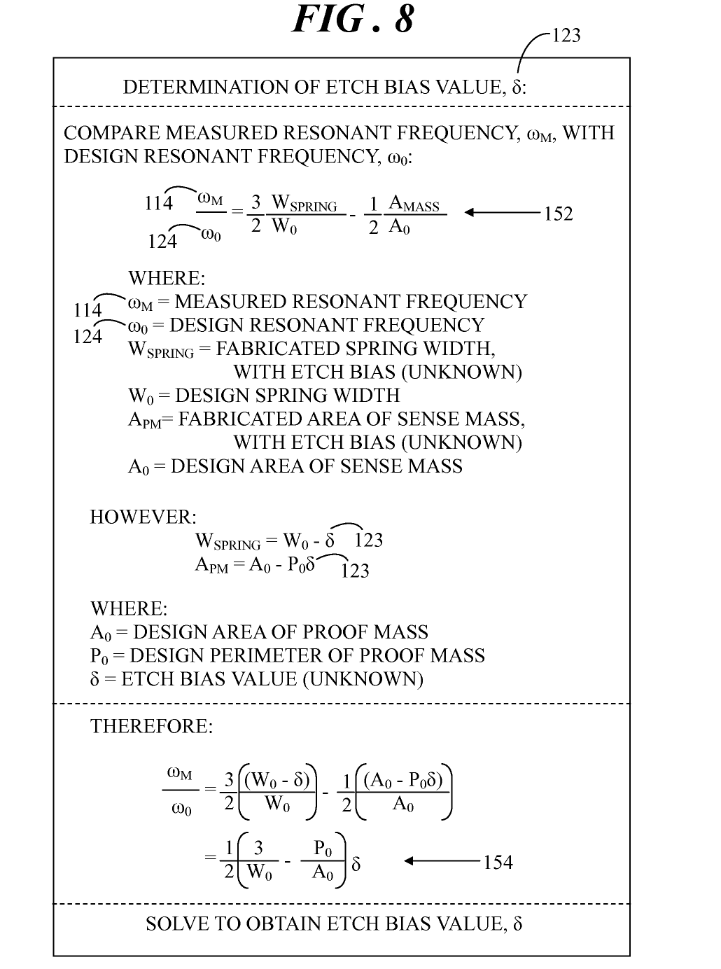

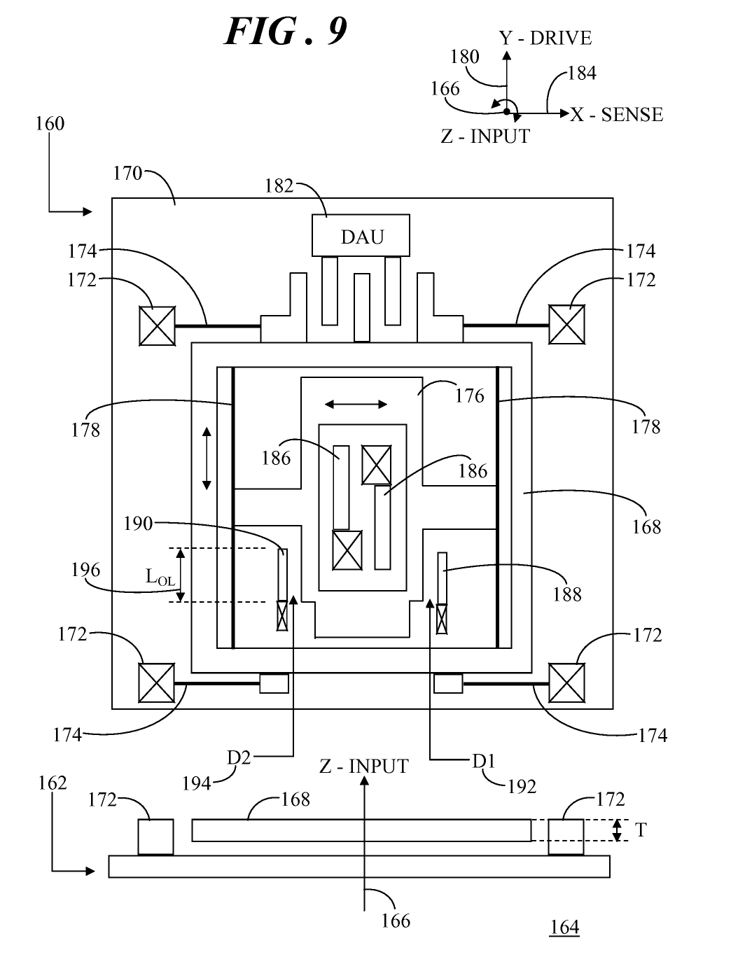

FIG. 8 shows a diagram of equations used to determine unknown process parameters using resonant frequency, ω_{M}, 114 of lateral acceleration sensor 68. As shown, a function 152 is defined in cooperation with subtask 120 (FIG. 3) of calibration process 60 (FIG. 3) as a ratio of the measured resonant frequency, ω_{M}, 114 to design resonant frequency, ω_{D}, 124. Function 152 depends upon the fabricated spring width, W_{SPRING}, the design spring width, W₀, the fabricated area of sense mass 74 (FIG. 4), A_{PM}, and the design area of sense mass 74, A₀. However, both W_{SPRING} and A_{PM} can be defined as a difference between the design parameters and etch bias value, δ, 123. Substitution of parameters as shown in FIG. 8 leads to an equation 154 in which again, the only unknown process parameter is etch bias value 123. Following the measurement of resonant frequency, ω_{M}, 114 equation 154 can be solved to obtain etch bias value 123.

After etch bias value 123 is extracted by solving equation 154, etch bias value 123 can be input into correlation function 148 (FIG. 7), or more specifically, the rearrangement of correlation function 148, i.e., function 150 (FIG. 7) to obtain SENS_{P} 112 (FIG. 7). Thus, SENS_{P} 112 can be calculated using SENS_{E} 108 (FIG. 7) and using measured resonant frequency, ω_{M}, 114 of lateral acceleration sensor 68 extract etch bias value 123.

The previous discussion utilizes electrical stimulus 44 (FIG. 1) to calibrate a lateral acceleration sensor. This calibration methodology may be implemented to calibrate an angular rate sensor, sometimes referred to as a gyroscope.

FIG. 9 shows a top view 160 and a side view 162 of an inertial sensor to be calibrated in accordance with calibration process 60 (FIG. 3). In this example, the inertial sensor includes an angular rate sensor 164, which is adapted to sense angular rate about an input axis 166, i.e., the Z axis, extending perpendicular to a lateral plane of angular rate sensor 164. Angular rate sensor 164 includes a drive mass in the form of a drive frame 168 suspended above an underlying substrate 170. Suspension anchors 172 are formed on substrate 170 and compliant members, referred to as drive springs 174, interconnect drive frame 168 with suspension anchors 172. A sense mass 176 is positioned inside of drive frame 168 and is attached to drive frame 168 with sense springs 178.

In the illustrated example, drive springs 174 allow sinusoidal movement of drive frame 168 and sense mass 176 along a drive axis 180, i.e., the Y axis. A drive actuation unit (DAU) 182 provides electrostatic actuation that causes the sinusoidal movement of drive frame 168 and sense mass 176 along drive axis 180. Sense springs 178 allow sinusoidal movement of sense mass 176 along a sense axis 184, i.e. the X axis, due to a Coriolis force generated in response to angular movement of angular rate sensor 164 about input axis 166 and the sinusoidal drive movement along drive axis 180. Fixed sense electrodes 186 sense the movement of sense mass 176 along sense axis 184.

Ideal operation of angular rate sensor 164 yields zero sense motion along sense axis 184 when angular rate sensor 164 is not experiencing angular movement about input axis 166. However, the non-ideal shape of drive springs 174 can result in movement of sense mass 176 along sense axis 184 when drive frame 168 moves along drive axis 180. Per convention, this movement is referred to as “quadrature motion.” Accordingly, angular rate sensor 164 further includes quadrature compensation electrodes 188 and 190 located proximate sense mass 176 so that sense gaps 192 and 194, labeled D1 and D2, respectively, are formed between quadrature compensation electrodes 188 and 190 and sense mass 176.

Quadrature compensation electrodes 188 and 190 overlap sense mass 176 by an overlap distance 196, L_{OL}, and the magnitude of overlap distance 196 changes with drive motion of sense mass 176 along drive axis 180. Quadrature compensation electrodes 188 and 190 are used to supply sinusoidal force on sense mass 176 along sense axis 184. By supplying suitable bias to quadrature compensation electrodes 188 and 190, the quadrature motion can be largely cancelled. In accordance with task 90 (FIG. 3) of calibration process 60 (FIG. 3), electrical stimulus 44 can be applied to quadrature compensation electrodes 188 and 190 to supply force, which mimics the Coriolis force in order to calibrate angular rate sensor 164.

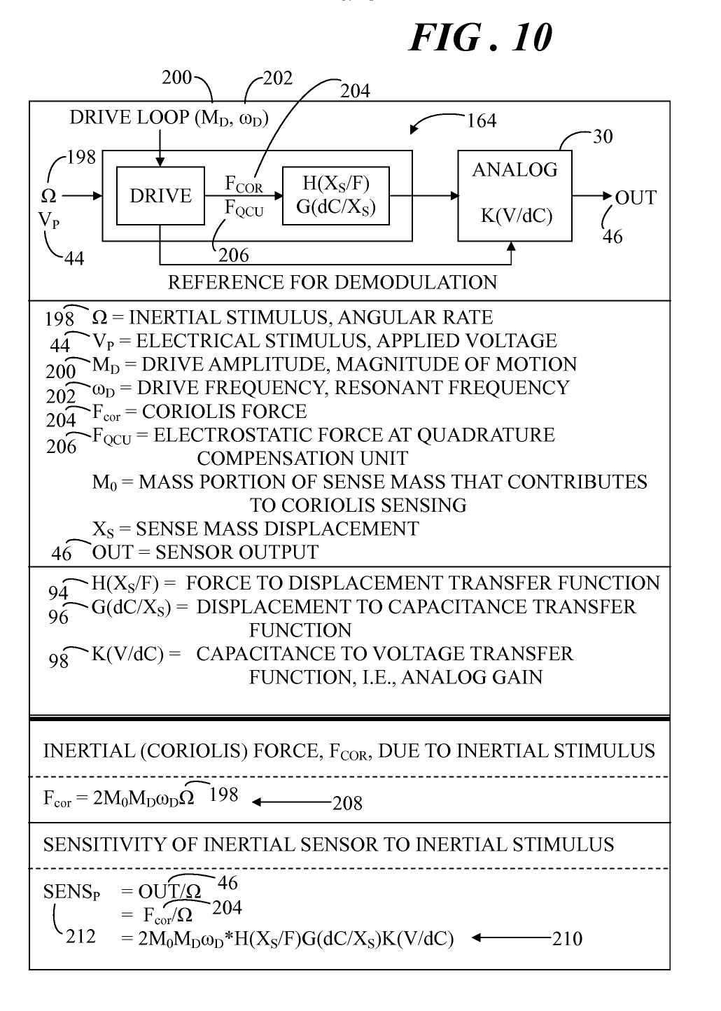

FIG. 10 shows a diagram illustrating an input of electrical stimulus 44 at quadrature compensation electrodes 188 and 190 (FIG. 9) for calibrating angular rate sensor 164 (FIG. 9) and the resulting output signal 46. FIG. 10 additionally shows an input of an inertial stimulus, i.e., an angular rate, Ω, 198. Angular rate sensor 164 includes a drive loop for oscillating drive frame 168 (FIG. 9) together with sense mass 176 (FIG. 9) at a drive amplitude, M_{D}, 200 and a drive frequency, ω_{D}, 202.

In response to inertial stimulus 198, angular rate sensor 164 produces a Coriolis force, F_{COR}, 204. Similarly, angular rate sensor 164 produces an electrostatic force, F_{QCU}, 206 at quadrature compensation electrodes 188 and 190 in response to electrical stimulus 44. Coriolis force 204 is the applied force resulting from an inertial stimulus, i.e., angular rate, Ω, 198 and may be processed to yield output signal 46. Electrostatic force 206 is the applied force resulting from electrical stimulus 44, and may also be processed to yield output signal 46. Like the previous example, the applied force (either Coriolis force 204 or the electrostatic force 206) may be combined with transfer functions H(X_{S}/F) 94, G(dC/X_{S}) 96, and K(V/dC) 98 to produce output signal 46.

Again, the nominal values of transfer functions H(X_{S}/F) 94 and G(dC/X_{S}) 96 result from the design of angular rate sensor 164 and cannot be adjusted to change an actual sensitivity, SENS_{P}, of angular rate sensor 164. Rather, the inevitable variation of transfer functions H(X_{S}/F) 94 and G(dC/X_{S}) 96 due to processing of angular rate sensor 164 can be compensated for by adjusting the gain in control circuit 30 of angular rate sensor 164, i.e., K(V/dC) 98. The gain of transfer function K(V/dC) 98 is adjusted using gain value 56 (FIG. 1) so that angular rate sensor 164 produces the correct voltage output per angular velocity input.

As further shown in FIG. 10, an inertial force equation 208 mathematically defines Coriolis force 204 resulting from an inertial (i.e., mechanical) stimulus 198. A sensitivity equation 210 may be used to define a sensitivity, SENS_{P} 212, of angular rate sensor 164 to Coriolis force 204.

As shown in inertial force equation 208, Coriolis force 204 is a product of the mass, M₀, of sense mass 176 (FIG. 9), drive amplitude 200, drive frequency 202, and the applied inertial stimulus, i.e., angular rate 198. Sensitivity equation 210 provides a mathematical definition of sensitivity, SENS_{P} 212, of angular rate sensor 164 to inertial stimulus 198. That is, sensitivity equation 210 relates Coriolis force 204, and inertial stimulus, Ω, 198 to output signal 46. As represented by sensitivity equation 210, inertial force equation 208 replaces F_{COR} in sensitivity equation 210 and transfer functions H(X_{S}/F) 94, G(dC/X_{S}) 96, and K(V/dC) 98 are applied to relate Coriolis force 204 to output signal 46.

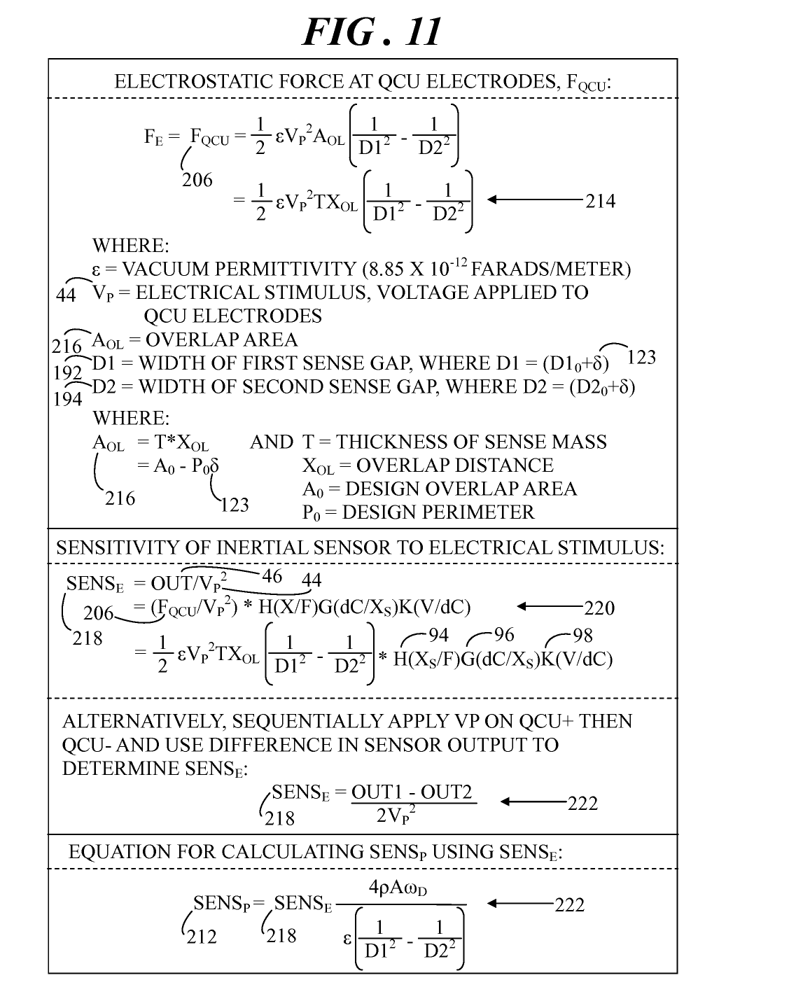

FIG. 11 shows a diagram of equations that determine a correlation between electrical stimulus 44 applied to angular rate sensor 164 (FIG. 9) and inertial stimulus, Ω, 198 to which angular rate sensor 164 may be subjected. Again, Coriolis force, F_{COR}, 204 is defined as the derivative of the energy, U, with respect to displacement, X_{S}, of sense mass 74 (FIG. 4) along sense axis 184 (FIG. 9) to produce an electrostatic force equation 214.

Electrostatic force equation 214 includes variables for a width of sense gap 192, i.e., D1, a width of sense gap 194, i.e., D2, and an overlap area, A_{OL}, 216. However, D1 is the sum of D1₀ (the design sense gap width of sense gap 192) and etch bias value, δ, 123. Likewise D2 is the sum of D2₀ (the design sense gap width of sense gap 194) and etch bias value 123. Accordingly, the width of sense gaps D1 and D2, 192 and 194, respectively, depend on a single process parameter, namely etch bias value 123. Overlap area 216, A_{OL}, is a product of the thickness, T, of the sense mass and overlap distance 196, L_{OL} (FIG. 9) which also depends on a single process parameter, i.e., etch bias value 123. The width of sense gaps D1 and D2, 192 and 194, and overlap area 216 all depend on etch bias value 123. Therefore, electrostatic force equation 214 includes a single unknown process parameter, etch bias value 123, which can be determined from a measured resonant frequency, ω_{M}, of angular rate sensor 164, as discussed in detail in connection with FIG. 8.

A sensitivity, SENS_{E} 218, of angular rate sensor 164 (FIG. 9) to electrical stimulus 44 can be obtained by dividing output signal 46 by the square of voltage amplitude of electrical stimulus 44. A sensitivity equation 220 provides a mathematical definition of sensitivity, SENS_{E} 218, of angular rate sensor 164 to electrical stimulus 44. That is, sensitivity equation 220 relates electrostatic force 204 and electrical stimulus 44 to output signal 46. As represented by sensitivity equation 220, electrostatic force equation 214 replaces F_{QCU} in sensitivity equation 220 and transfer functions H(X_{S}/F) 94, G(dC/X_{S}) 96, and K(V/dC) 98 are applied to relate electrostatic force 204 to output signal 46. Accordingly, sensitivity equation 220 describing SENS_{P} 218 includes one unknown process parameter, namely etch bias value 123.

In an embodiment, quadrature compensation electrode 188 (FIG. 9) is a positive quadrature compensation electrode 188 and quadrature compensation electrode 190 (FIG. 9) is a negative quadrature compensation electrode 190. SENS_{E} 218 may alternatively be determined by sequentially applying electrical stimulus 44 to positive quadrature compensation electrode 188 and quadrature compensation electrode 190, receiving respective output signals 46 (OUT1 and OUT2), and using the difference between output signals OUT1 and OUT2 to determine SENS_{E} 218 as represented in a sensitivity equation 222. Such a technique for determining SENS_{E} 218 may useful should the applied voltage, i.e., electrical stimulus 44, cause electrical spring constant softening which could affect the value of SENS_{E} 218.

A correlation function can be defined as a ratio of SENS_{P} to SENS_{E}. Simplification of the correlation function yields an equation 224 for calculating SENS_{P} 212, i.e., the sensitivity of angular rate sensor 164 (FIG. 10) to inertial stimulus 198 (FIG. 10) using SENS_{E} 218, i.e., the sensitivity of angular rate sensor 164 to electrical stimulus 44. Due to the derivation of equation 222, SENS_{P} 212 depends upon a single unknown process parameter, i.e., etch bias value, δ, 123. However, etch bias value 123 can be obtained by measuring resonant frequency, ω_{M}, 114, of angular rate sensor 164, as discussed in connection with FIG. 8, so that SENS_{P} 212 can be readily calculated using SENS_{E} 218.

Previous examples utilize a measured resonant frequency to extract at least one unknown process parameter value, e.g., etch bias value 123. Once etch bias value 123 is known it can be used in cooperation with the sensitivity of an inertial sensor to an electrical stimulus in order to calculate a sensitivity of the inertial sensor to an inertial stimulus.

Accordingly, an inertial sensor (e.g., a lateral acceleration sensor or an angular rate sensor) can be calibrated without subjecting the inertial sensor to an inertial (i.e., mechanical) stimulus. The following discussion presents an example in which sensitivity of an inertial sensor to an electrical stimulus and a resonant frequency of the inertial sensor are used to calibrate a Z-axis accelerometer to solve multiple variables without subjecting the Z-axis accelerometer to an inertial stimulus.

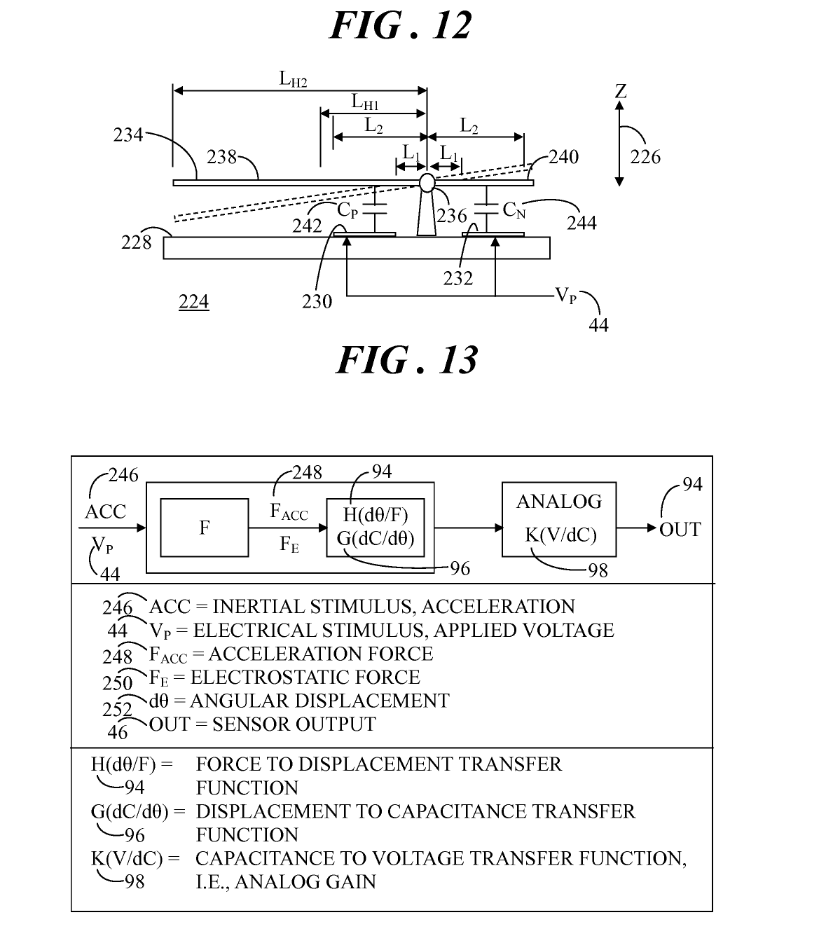

FIG. 12 shows a block diagram of yet another inertial sensor to be calibrated in accordance with calibration process 60 (FIG. 3). In particular, the inertial sensor includes an acceleration sensor 224 whose sense axis 226 is perpendicular to a lateral plane of acceleration sensor 224. Thus, acceleration sensor 224 is referred to herein as vertical axis acceleration sensor 224.

Vertical axis acceleration sensor 224 is constructed as a conventional hinged or “teeter-totter” type sensor. Vertical axis acceleration sensor 224 includes a substrate 228 having conductive sense electrodes 230 and 232 of a predetermined configuration deposited on the surface to form respective capacitor electrodes or “plates.” A movable element, referred to as a sense mass 234, is flexibly suspended above substrate 228 and rotates about a rotational axis 236. A section 238 of sense mass 234 on one side of rotational axis 236 is formed with relatively greater mass than a section 240 of sense mass 234 on the other side of rotational axis 236. The greater mass of section 238 is typically created by offsetting rotational axis 236 from a geometric center of sense mass 234. Due to the differing masses on either side of rotational axis 236, sense mass 234 pivots or rotates in response to acceleration along sense axis 226, thus changing its position relative to the sense electrodes 230 and 232. This change in position results in a change in electrical capacitance between movable element 28 and each of electrodes 230 and 232. Capacitors 242 and 244 represent this capacitance, or more particularly the change in capacitance, as sense mass 234 pivots in response to acceleration. The difference between the capacitance, i.e., a differential capacitance, is indicative of acceleration. It should be understood that capacitors 242 and 244 are symbolic of this capacitance, and are not physical components of vertical axis acceleration sensor 224.

In accordance with an embodiment, a 1 g gravitational field and applied voltages for electrical stimulus 44 are utilized so that the resonant frequency and offset of vertical axis acceleration sensor 224 can be measured and used for extracting a sensitivity for sensor 224. Electrical stimulus 44 is applied on both of sense electrodes 230 and 232.

Referring to FIG. 13 in connection with FIG. 12, FIG. 13 shows a diagram illustrating an input of electrical stimulus 44 at sense electrodes 230 and 232 for calibrating vertical axis acceleration sensor 224. FIG. 13 additional shows an input of an inertial stimulus, i.e., acceleration, ACC 246. In response to acceleration 246, acceleration sensor 224 produces an acceleration force, F_{ACC}, 248. Similarly, acceleration sensor 224 produces an electrostatic force, F_{E}, 250, in response to electrical stimulus 44. Acceleration force 248 is the applied force resulting from acceleration 246 and may be processed to yield output signal 46. Electrostatic force 248 is the applied force resulting from electrical stimulus 44 and may also be processed to yield output signal 46.

Like the previous examples, the applied force (either acceleration force 248 or electrostatic force 250) may be combined with transfer functions H(dθ/F) 94, G(dC/dθ) 96, and K(V/dC) 98 to produce output signal 46. In this instance, the previously used term “X_{S}” is replaced by the term “dθ” which represents an angular displacement 252 of sense mass 234.

That is, vertical axis acceleration sensor 224 rotates about an angle, θ, instead of moving a translational distance, X_{S}.

Again, the nominal values of transfer functions H(dθ/F) 94 and G(dC/dθ) 96 result from the design of vertical axis acceleration sensor 224 and cannot be adjusted to change an actual sensitivity, SENS_{P}, of acceleration sensor 224. Rather, the inevitable variation of transfer functions H(dθ/F) 94 and G(dC/dθ) 96 due to processing of angular rate sensor 164 can be compensated for by adjusting the gain in control circuit 30 of angular rate sensor 164, i.e., K(V/dC) 98. The gain of transfer function K(V/dC) 98 is adjusted using gain value 56 (FIG. 1) so that vertical axis acceleration sensor 224 produces the correct voltage output per angular velocity input.

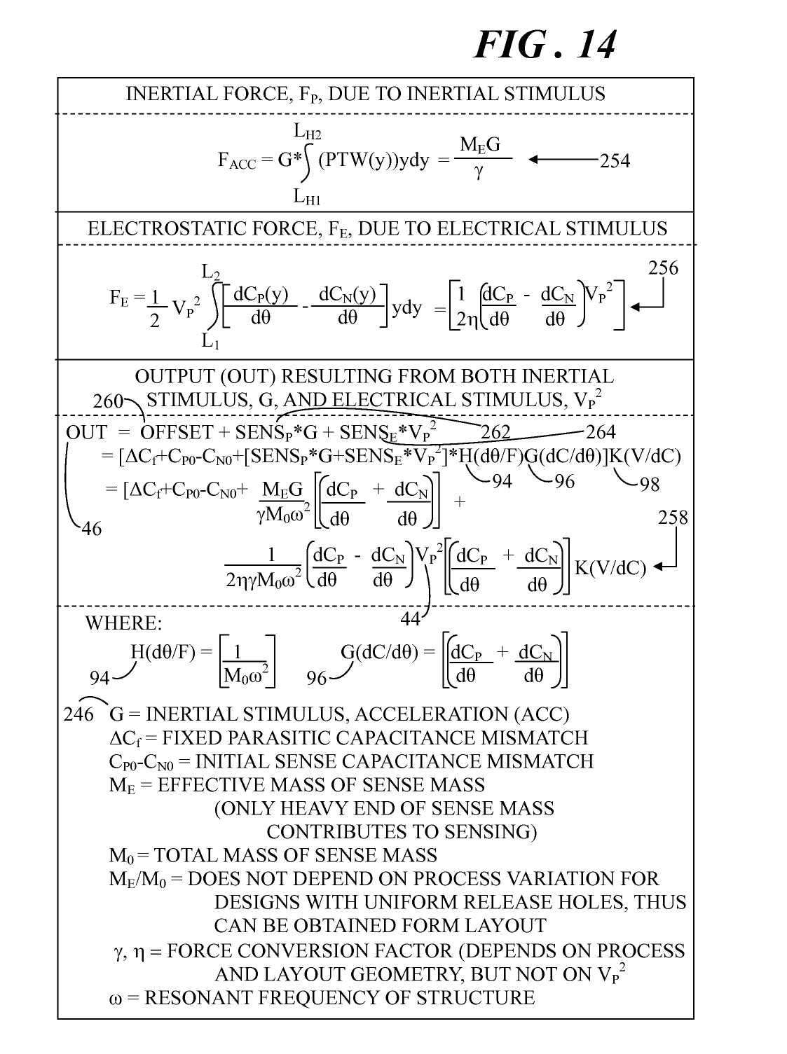

FIG. 14 shows a diagram of equations that define an output signal from vertical axis acceleration sensor 224 (FIG. 12). An inertial force equation 254 mathematically defines acceleration force 248 resulting from acceleration 246. Referring briefly to FIG. 12, section 238 having the greater mass is the primary contributor to acceleration force 248. This “heavy end” of section 238 is distinguished by L_{H1} and L_{H2}. Accordingly, acceleration force 248 can be defined by finding a derivative over L_{H1} to L_{H2} of the process parameters. In this example, inertial force equation 254 is simplified to be a function of the magnitude of acceleration 246, represented by the symbol “G,” an effective mass of sense mass, M_{E}, and a force conversion factor, γ, where the force conversion factor, γ, depends upon process and layout geometry (i.e., L_{H1} and L_{H2}).

As further shown in FIG. 14, an electrostatic force equation 256 is defined with respect to the angular displacement, dθ, of sense mass 234 (FIG. 12) of vertical axis acceleration sensor 224 (FIG. 12) in response to electrical stimulus 44. That is, electrostatic force equation 256 mathematically defines electrostatic force 250 resulting from electrical stimulus. Electrostatic force can be defined by finding a derivative over L₁ to L₂ of the process parameters (i.e., the locations of sense electrodes 230 and 232, see FIG. 12). In this example, electrostatic force equation 256 is simplified to be a function of the amplitude of electrical stimulus 44, represented by the symbol “V_{P},” a force conversion factor, η, where the force conversion factor, η, depends upon process and layout geometry (i.e., L₁ and L₂), and a difference between capacitance mismatch (dC_{P} and dC_{N}) relative to angular displacement, dθ.

Accordingly, under 1 g gravity field and an applied voltage (i.e., electrical stimulus 44), output signal, OUT, 46 results from both the magnitude of acceleration, G, and the amplitude of electrical stimulus 44, V_{P}. An output equation 258, is provided that exemplifies output signal 46 resulting from the relationship between a sensor offset, OFFSET, 260, a sensitivity, SENS_{P}, 262 of acceleration sensor 224 (FIG. 12) to acceleration 246, and a sensitivity, SENS_{E}, 264 of acceleration sensor 224 to electrical stimulus 44, as well as transfer functions H(dθ/F) 94, G(dC/dθ) 96, and K(V/dC) 98. Output equation 258 is derived through the fundamental physics of vertical axis acceleration sensor 224, i.e., a parallel plate capacitor equation, rigid body “teeter-totter” mechanics, and so forth known to those skilled in the art.

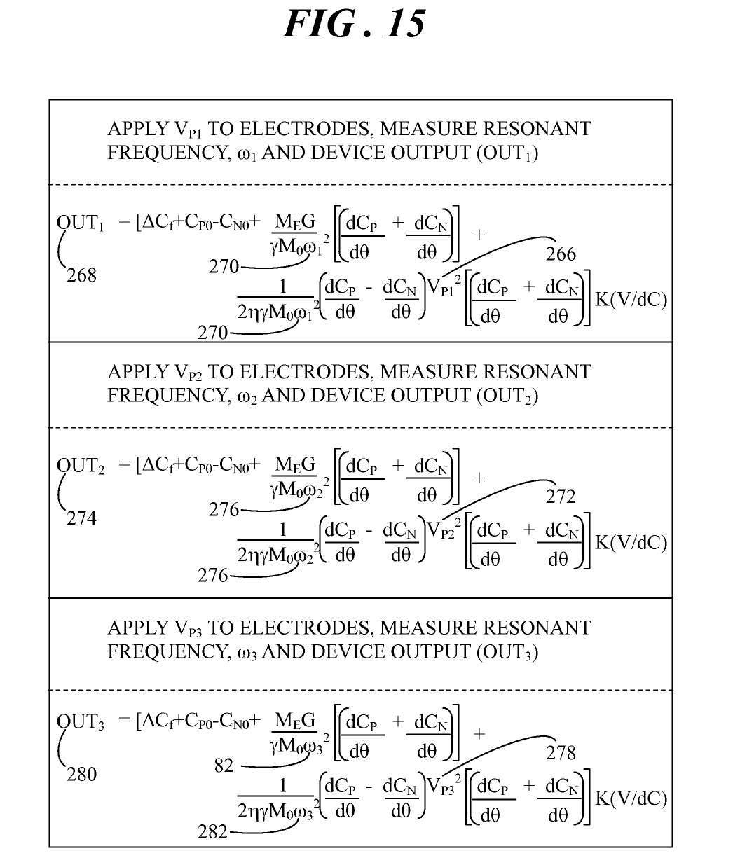

FIG. 15 shows a diagram of output equations that illustrate the application of electrical stimulus 44 of various voltages which may be applied for calibrating vertical axis acceleration sensor 224 (FIG. 12). In accordance with an adaptation of calibration process 60 (FIG. 3), three biases (i.e., three occurrences of electrical stimulus 44 at differing voltage amplitudes) are sequentially applied to yield sufficient information to solve for multiple unknown parameters in order to determine sensitivity, SENS_{P}, 262 of acceleration sensor 224 (FIG. 12) to acceleration 246 using a sensitivity, SENS_{E}, 264 of acceleration sensor 224 to electrical stimulus 44 and measured resonant frequencies, ω, of sensor 224 at each bias.

Accordingly, electrical stimulus 44 at a first amplitude, V_{P1}, 266 is applied to both of sense electrodes 230 and 232 (FIG. 12), a first output signal, OUT₁, 268 is received, and a first resonant frequency, ω₁, 270 is measured. Next, electrical stimulus 44 at a second amplitude, V_{P2}, 272 is applied to both of sense electrodes 230 and 232, a second output signal, OUT₂, 274 is received, and a second resonant frequency, ω₂, 276 is measured. Finally, electrical stimulus 44 at a third amplitude, V_{P3}, 278 is applied to both of sense electrodes 230 and 232, a third output signal, OUT₃, 280 is received, and a third resonant frequency, ω₃, 282 is measured.

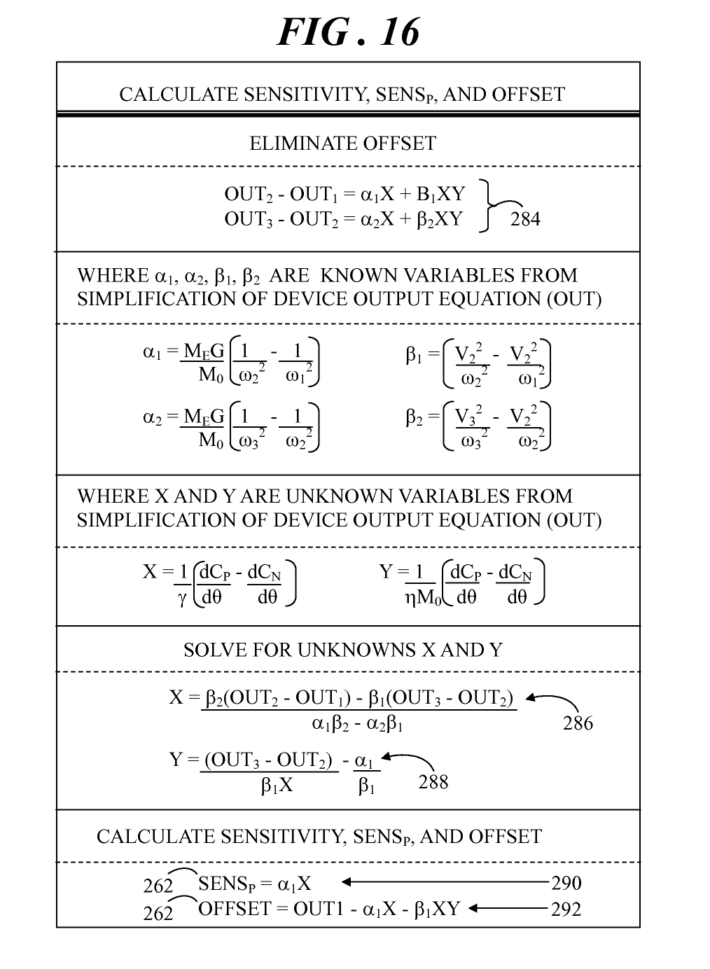

FIG. 16 shows a diagram of equations used to calibrate sensitivity 262 and offset 260 for the inertial sensor of FIG. 12. A pair of equations 284 are presented for eliminating offset using first output signal 268, second output signal 274, and third output signal 280, where α₁, α₂, β₁, and β₂ are known parameters and X and Y are unknown variables from the simplification of output equation 258 (FIG. 14). An equation 286 illustrates a solution for the unknown variable, X, and an equation 288 illustrates a solution for the unknown variable, Y. The unknown variables X and Y can be solved using first amplitude, V_{P1}, 266, first output signal, OUT₁, 268, the measured first resonant frequency, ω₁, 270, second amplitude, V_{P2}, 272, second output signal, OUT₂, 274, the measured second resonant frequency, ω₂, 276, third amplitude, V_{P3}, 278, third output signal, OUT₃, 280, and the measured third resonant frequency, ω₃, 282. Once X and Y are known, a sensitivity equation 290 can be solved to calculate sensitivity, SENS_{P}, 262 and offset 260 for vertical axis acceleration sensor 224 (FIG. 12) to an inertial stimulus, e.g., acceleration 246 (FIG. 13). Similar to previous the discussion, sensitivity, SENS_{P}, 262 can be utilized to adjust gain value 56 (FIG. 1) particular to vertical axis acceleration sensor 224 so that SENS_{P} 262 more closely matches a design sensitivity 53 (FIG. 1) specific to sensor 224.

Thus, in this example, a 1 g gravitational field and several electrical tests (i.e., the electrical stimulus 44 at differing voltage amplitudes) can be implemented in order to sort out what the response of vertical axis acceleration sensor 224 would be to a changing g-field without subjecting sensor 224 to an inertial stimulus, a i.e., physical movement relative to sense axis 226 (FIG. 12). Therefore, sensitivity, SENS_{P}, 262 for vertical axis acceleration sensor 224 can be calculated in response to (i.e., using) sensitivity, SENS_{E}, of sensor 224 to electrostatic force, F_{E}, 250, and resonant frequencies 270, 276, and 282.

Embodiments described herein entail a calibration system and methodology for factory calibration of an inertial sensor. The methodology directly correlates an inertial, i.e., physical stimulus, with an electrical stimulus applied to the inertial sensor by measuring the resonant frequency of the inertial sensor so that the sensitivity of the inertial sensor can be calibrated, or trimmed, without subjecting the inertial sensor to an inertial stimulus. The methodology may be implemented to calibrate, for example, a lateral acceleration sensor, a vertical axis angular rate sensor, a vertical axis acceleration sensor, and so forth. Thus, accurate calibration can be achieved without subjecting the inertial sensors to physical stimuli typically imparted by costly mechanical platforms and associated calibration procedures. Moreover, the calibration methodology can be applied concurrently to multiple inertial sensors for improvements in parallelism, and the calibration methodology can be applied to a variety of inertial sensor designs.

Although the preferred embodiments of the invention have been illustrated and described in detail, it will be readily apparent to those skilled in the art that various modifications may be made therein without departing from the spirit of the invention or from the scope of the appended claims. For example, the calibration process operations may be performed in a differing order then that which was presented.

What is claimed is:

1. A method for calibrating an inertial sensor comprising:
applying an electrical stimulus to said inertial sensor;
receiving an output signal from said inertial sensor produced in response to said electrical stimulus;
determining a first sensitivity of said inertial sensor in response to said received output signal and an applied voltage of said electrical stimulus;
calculating a second sensitivity for said inertial sensor using said first sensitivity and a resonant frequency of said inertial sensor; and
utilizing said second sensitivity to adjust a gain value for said inertial sensor to calibrate said inertial sensor.

2. A method as claimed in claim 1 wherein said inertial sensor includes an acceleration sensor having a sense mass that is movable in response to acceleration of said acceleration sensor along a sense axis, said sense axis being approximately parallel to a lateral plane of said acceleration sensor, and said applying operation applies said electrical stimulus between said sense mass and a fixed sense electrode to generate an electrostatic force that moves said sense mass along said sense axis to simulate acceleration along said sense axis.

3. A method as claimed in claim 1 wherein:
said inertial sensor includes an angular rate sensor having a drive mass able to oscillate in a lateral plane of said angular rate sensor along a drive axis and a sense mass able to oscillate in said lateral plane along a sense axis approximately perpendicular to said drive axis in response to angular movement of said angular rate sensor about an input axis that is approximately perpendicular to said drive axis and said sense axis, said angular rate sensor including at least one quadrature compensation electrode associated with said drive mass;
said method further comprises oscillating said drive mass together with said sense mass at a drive amplitude and drive frequency; and
said applying operation applies said electrical stimulus to said at least one quadrature compensation electrode to generate an electrostatic force that causes said sense mass to oscillate along said sense axis to simulate said angular movement of said angular rate sensor about said input axis.

4. A method as claimed in claim 3 further comprising measuring said output signal at an output terminal of said quadrature compensation electrode.

5. A method as claimed in claim 3 wherein:
said at least one quadrature compensation electrode includes a positive quadrature compensation electrode and a negative quadrature compensation electrode;
said applying operation comprises sequentially applying said electrical stimulus to one of said positive and negative quadrature compensation electrodes;
said receiving operation comprises measuring a first output signal when said electrical stimulus is applied to said positive quadrature compensation electrode and measuring a second output signal when said electrical stimulus is applied to said negative quadrature compensation electrode; and
said determining operation comprises determining said first sensitivity in response to a difference between said first and second output signals and said applied voltage of said electrical stimulus.

6. A method as claimed in claim 1 wherein said inertial sensor includes an acceleration sensor having a sense mass that is movable about an axis of rotation in response to acceleration along a sense axis that is approximately perpendicular to a lateral plane of said acceleration sensor, and said applying operation applies said electrical stimulus between said sense mass and a fixed sense electrode under a gravity field to generate an electrostatic force that moves said sense mass about said axis of rotation to simulate acceleration along said sense axis.

7. A method as claimed in claim 1 wherein said calculating operation determines a correlation between a response of said inertial sensor to said electrical stimulus and a response of said inertial sensor to an inertial stimulus to determine said second sensitivity.

8. A method as claimed in claim 1 further comprising:
defining a correlation function that correlates said electrical stimulus with an inertial stimulus on said inertial sensor, said correlation function depending upon at least one unknown process parameter;
measuring said resonant frequency of said inertial sensor;
extracting at least one parameter value for each of said at least one unknown process parameter utilizing said measured resonant frequency; and
inputting said at least one parameter value into said correlation function to calculate said second sensitivity.

9. A method as claimed in claim 8 wherein said at least one unknown process parameter includes an etch bias value, and said extracting operation comprises:
comparing said measured resonant frequency with a design resonant frequency for said inertial sensor and geometric parameters of said inertial sensor; and
obtaining said etch bias value in response to said comparing operation.

10. A method as claimed in claim 1 wherein said inertial sensor is manufactured having a predetermined design sensitivity, and said utilizing operation comprises setting said gain value to be a ratio of said design sensitivity to said second sensitivity.

11. A method as claimed in claim 11 wherein said gain value is adjusted without subjecting said inertial sensor to an inertial stimulus.

12. A system for calibrating an inertial sensor comprising:
a signal generator for producing an electrical stimulus;
an output element coupled to said signal generator and configured for communication with said inertial sensor, wherein said electrical stimulus is applied to said inertial sensor via said output element;
an input element configured for communication with an output of said inertial sensor for receiving an output signal from said inertial sensor produced in response to said electrical stimulus;
a processing system coupled to said input element, said processing system having computer readable media associated therewith, said computer readable media storing including executable code for instructing said processing system to perform operations comprising:
determining a first sensitivity of said inertial sensor in response to said received output signal and an applied voltage of said electrical stimulus;
calculating a second sensitivity for said inertial sensor using said first sensitivity and a resonant frequency of said inertial sensor; and
utilizing said second sensitivity to produce a gain value for said inertial sensor; and
a gain adjust output element coupled to said processing system and adapted to communicate said gain value to said inertial sensor to calibrate said inertial sensor without subjecting said inertial sensor to an inertial stimulus.

13. A system as claimed in claim 12 wherein said inertial sensor includes an acceleration sensor having a sense mass that is movable in response to acceleration of said acceleration sensor along a sense axis, said sense axis being approximately parallel to a lateral plane of said acceleration sensor, and said output element is configured to be coupled to said inertial sensor to apply said electrical stimulus between said sense mass and a fixed sense electrode to generate an electrostatic force that moves said sense mass along said sense axis to simulate acceleration along said sense axis.

14. A system as claimed in claim 12 wherein said inertial sensor includes an angular rate sensor having a drive mass able to oscillate in a lateral plane of said angular rate sensor along a drive axis and a sense mass able to oscillate in said lateral plane along a sense axis approximately perpendicular to said drive axis in response to angular movement of said angular rate sensor about an input axis that is approximately perpendicular to said drive axis and said sense axis, said angular rate sensor including at last one quadrature compensation electrode associated with said drive mass, and said angular rate sensor being driven to oscillate said drive mass together with said sense mass at a drive amplitude and drive frequency, wherein:
said output element is configured to be coupled to said inertial sensor to apply said electrical stimulus to said at least one quadrature compensation electrode to generate an electrostatic force that causes said sense mass to oscillate along said sense axis to simulate said angular movement of said inertial sensor about said input axis.

15. A system as claimed in claim 12 wherein said inertial sensor includes an acceleration sensor having a sense mass that is movable about an axis of rotation in response to acceleration along a sense axis that is approximately perpendicular to a lateral plane of said acceleration sensor, and said output element is configured to be coupled to said inertial sensor to apply said electrical stimulus between said sense mass and a fixed sense electrode under a gravity field to generate an electrostatic force that moves said sense mass about said axis of rotation to simulate acceleration along said sense axis.

16. A method for calibrating an inertial sensor, said inertial sensor being manufactured to have a predetermined design sensitivity, said method comprising:
applying an electrical stimulus to an electrode of said inertial sensor;
receiving an output signal from said inertial sensor produced in response to said electrical stimulus;
determining a first sensitivity of said inertial sensor in response to said measured output signal and an applied voltage of said electrical stimulus;
calculating a second sensitivity for said inertial sensor using said first sensitivity and a resonant frequency of said inertial sensor, said calculating operation including determining a correlation between a response of said inertial sensor to said electrical stimulus and a response of said inertial sensor to an inertial stimulus to determine said second sensitivity; and
utilizing said second sensitivity to adjust a gain value for said inertial sensor to calibrate said inertial sensor, wherein said gain value is set to be a ratio of said design sensitivity to said second sensitivity.

17. A method as claimed in claim 16 further comprising:
defining a correlation function that correlates said electrical stimulus with said inertial stimulus on said inertial sensor, said correlation function depending upon at least one unknown process parameter;
measuring said resonant frequency of said inertial sensor;
extracting at least one parameter value for each said at least one unknown process parameter utilizing said measured resonant frequency; and
inputting said at least one parameter value into said correlation function to calculate said second sensitivity.

18. A method as claimed in claim 17 wherein said at least one unknown process parameter includes an etch bias value, and said extracting operation comprises:
comparing said measured resonant frequency with a design resonant frequency for said inertial sensor and geometric parameters of said inertial sensor; and
obtaining said etch bias value in response to said comparing operation.

19. A method as claimed in claim 16 wherein said gain value is set without subjecting said inertial sensor to an inertial stimulus.

20. A method as claimed in claim 16 wherein said inertial sensor includes an acceleration sensor having a sense mass that is movable in response to acceleration of said acceleration sensor along a sense axis, said sense axis being approximately parallel to a lateral plane of said acceleration sensor, and said applying operation applies said electrical stimulus between said sense mass and a fixed sense electrode to generate an electrostatic force that moves said sense mass along said sense axis to simulate acceleration along said sense axis.
